(19) United States
(12) Patent Application Publication
(10) Pub. No.: US 2003/0214958 A1
(43) Pub. Date: Nov. 20, 2003

(54) Linking of bearer and control for a multimedia session

(76) Inventors: Lila Madour, Kirkland (CA); Nadia Bishai, Town of Mount Royal (CA); Nancy M. Greene, Outremont (CA)

Correspondence Address: ALEX NICOLAESCU, Ericsson Canada Inc., Patent Department (LMC/M/P), 8400 Decarie Blvd., Town Mount Royal, QC, H4P 2N2, CA

(21) Appl. No.: 10/412,307

(22) Filed: Apr. 14, 2003

Related U.S. Application Data
(60) Provisional application No. 60/371,707, filed on Apr. 12, 2002.

(51) Int. Cl. H04L 12/28

(52) U.S. Cl. 370/401; 370/395.2

(57) ABSTRACT

The present invention relates to a method for linking control and bearer for a multimedia session in an ALL-IP network, and to an Access Gateway (AGW) and an Authentication, Authorization, and Accounting (AAA) server therefore. For doing so, a Mobile IP Request message is received at the AGW from a terminal. The AGW requests authentication of the terminal at the AAA server. The AAA server allocates a Proxy Session Control Manager (P-SCM) for the terminal. Then, the AAA sends an identity of the P-SCM to the AGW, and stores the identity of the allocated P-SCM for the terminal.

### PRIORITY STATEMENT UNDER 35 U.S.C S.119 (e) & 37 C.F.R. S.1.78

This non-provisional patent application claims priority based upon the prior U.S. provisional patent application entitled “LINKING OF BEARER AND CONTROL FOR A SIP SESSION”, application Ser. No. 60/371,707, filed Apr. 12, 2002, in the names of Lila Madour, Nadia Bishai, and Nancy M. Greene.

### BACKGROUND OF THE INVENTION

1. Field of the Invention

The invention relates to a method for providing linking of bearer and control of a multimedia session in an ALL-IP network.

2. Description of the Related Art

As of today, ALL-IP networks are being standardized by organizations such as the 3^{rd} Partnership Project 2 (3GPP2) for supporting multimedia services such as Internet multimedia conferences, Internet (or any IP Network) telephone calls and multimedia distribution. ALL-IP networks are also being standardized for migrating current SS7 infrastructures to an ALL-IP distributed network. The 3GPP2 ALL-IP network is based on the concept of separating session control signaling from bearer plane (transport packet data on a connection). This particular concept is not common in current SS7 networks. With the introduction of ALL-IP networks, services will be provided to a subscriber of a terminal subscriber using the IP technology.

A 3GPP2 ALL-IP network comprises among other things an Access Network for accessing an IP-based Core Network based on a request sent by a terminal. The Core Network comprises an Access Gateway for providing routing capabilities and for handling a bearer for the terminal, an Authorization, Authentication, and Accounting (AAA) server for providing authorizing, authenticating and charging capabilities for the terminal, and a Proxy-Session Control Manager (P-SCM) associated to the terminal for controlling signaling during a multimedia session such as a Session Initiation Protocol (SIP) session.

SIP (Session Initiation Protocol) is a protocol, which is included herewith by reference, developed to assist in providing advanced telephony services across the Internet and has been chosen by 3GPP2 for initiating multimedia session for a mobile station subscriber. SIP is part of the Internet Engineering Task Force (IETF) standards process, which is included herewith by reference, and is modeled upon other Internet Protocols such as SMTP (Simple Mail Transfer Protocol) and HTTP (Hypertext Transfer Protocol.). It is used to establish, change and tear down (end) calls between one or more terminals in an IP-based network. In order to provide telephony services using SIP there is a need for a number of different standards and protocols, which are included herewith by reference, to come together to ensure transport (RTP), signaling inter-working within a telephony network, to be able to guarantee voice quality (RSVP, YESSIR), to be able to provide directories (LDAP), and to authenticate terminals (RADIUS, DIAMETER). It also supports a terminal's mobility by proxying and redirecting requests to the terminal's current location.

The 3GPP2 ALL-IP network also comprises other packet data nodes such as databases, servers and gateways. A terminal is defined in a Home network and may roam in a Visited network. In the currently defined ALL-IP network, the Visited network may have one or more P-SCMs. The terminal must use a P-SCM in the Home network, the Visited network or in any external network while roaming and when accessing multimedia services from an IP network (e.g. Internet). When the terminal has been authorized by an AAA server to receive multimedia services in the ALL-IP network, the terminal discovers a P-SCM that it needs to use in the visited network. An Access Gateway (AGW) is the point of attachment for the mobile user, through which all session control signaling is transmitted between the terminal and any of the P-SCM provided by the Visited network or by an external network.

In order for a terminal to request access for multimedia services, it must first access the ALL-IP network via either Simple IP or Mobile IP. These requests (Simple IP and Mobile IP) are defined in IS-835B. CDMA2000 Wireless IP network standard, which is included herewith by reference. In this standard, Mobile IP refers to a service in which the terminal is able to maintain a persistent IP address even when handing off between Access networks (e.g. Radio Access Networks (RANs)) or AGWs (e.g. Packet Data Serving Node (PDSN)). Simple IP refers to a service that provides an IP address to the terminal and that further provides IP routing by utilizing an Access network. The terminal keeps its IP address as long as it is served by a same AGW. Therefore, when the terminal roams from one AGW to another it has to receive a new IP address.

In 3GPP2 ALL-IP networks, a subscriber of a terminal can use IP applications such as in Internet. Since 3GPP2 ALL-IP networks are based on the model of separation of control (signaling) and bearer plane (transport packet data on a connection), the session control signaling is rendered transparent to an AGW that controls access and transport to the 3GPP2 ALL-IP network for a terminal. Therefore, it is not possible for telecommunication service providers to charge terminal subscribers for those services in the current 3GPP2 ALL-IP network. For that reason, a method is necessary for managing resources in use in the 3GPP2 ALL-IP network in a way to be able to provide an accurate charging for multimedia services. Also, since control and bearer are separated, it is not possible to tear down control resources being used when a bearer is lost. The invention provides a solution to these problems.

### SUMMARY OF THE INVENTION

It is therefore one broad object of this invention to provide a method for linking control and bearer for a multimedia session in an ALL-IP network, the method comprising steps of:

receiving at an Access Gateway (AGW) a Mobile IP Request message from a terminal;

requesting by the AGW authentication of the terminal at an Authentication, Authorization, and Accounting (AAA) server;

allocating at the AAA a Proxy Session Control Manager (P-SCM) for the terminal;

sending from the AAA an identity of the P-SCM to the AGW; and

storing at the AGW the identity of the allocated P-SCM for the terminal.

It is therefore another broad object of his invention to provide an Access Gateway (AGW) for storing an identity of a Proxy-Session Control manager (P-SCM), the AGW being capable of:

receiving a Mobile IP request from a terminal;

forwarding the Mobile IP request to an AAA in an Authentication/Authorization Request message;

receiving an Authentication/Authorization Response message from the AAA, the message including an identity of a P-SCM allocated for the terminal; and

storing the identity of the P-SCM in an internal memory.

It is therefore another broad object of his invention to provide an Authentication, Authorization, and Accounting (AAA) server for allocating a Proxy Session Control Manager (P-SCM) to a terminal, the AAA being capable of:

receiving an Authentication/Authorization Request message from an Access Gateway, the Authentication/Authorization Request message including a Mobile IP Request received from the terminal;

using the Mobile IP Request and an attribute of the AAA, allocating the P-SCM; and

informing the Access Gateway of the allocated P-SCM for the terminal.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a signal flow diagram illustrating a flow of messages for linking bearer and control in an ALL-IP network r in accordance with an embodiment of the invention;

FIG. 2 is a signal flow diagram illustrating a flow of messages for linking bearer and control in an ALL-IP network in accordance with an embodiment of the invention;

FIG. 3 is a schematic diagram illustrating an Access Gateway (AGW) for storing an identity of a P-SCM in accordance to the invention; and

FIG. 4 is a schematic diagram illustrating an AAA server in accordance to the invention.

### DETAILED DESCRIPTION OF THE PREFERRED EMBODIMENTS

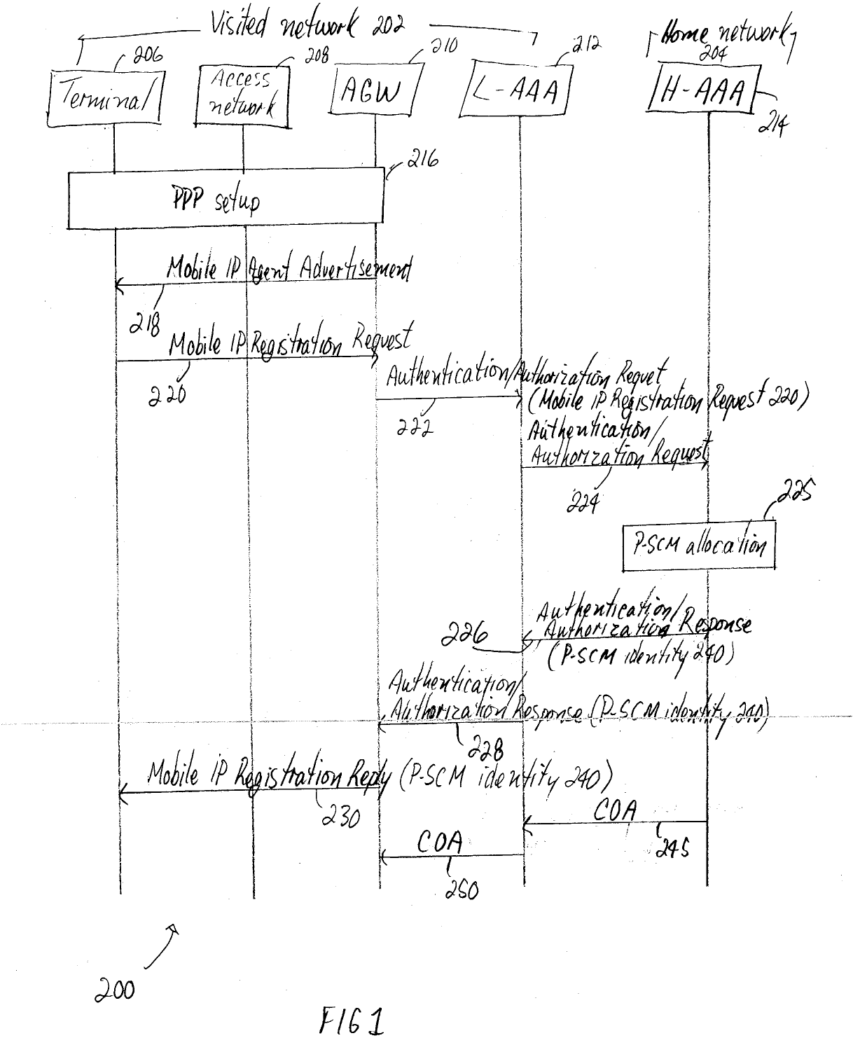

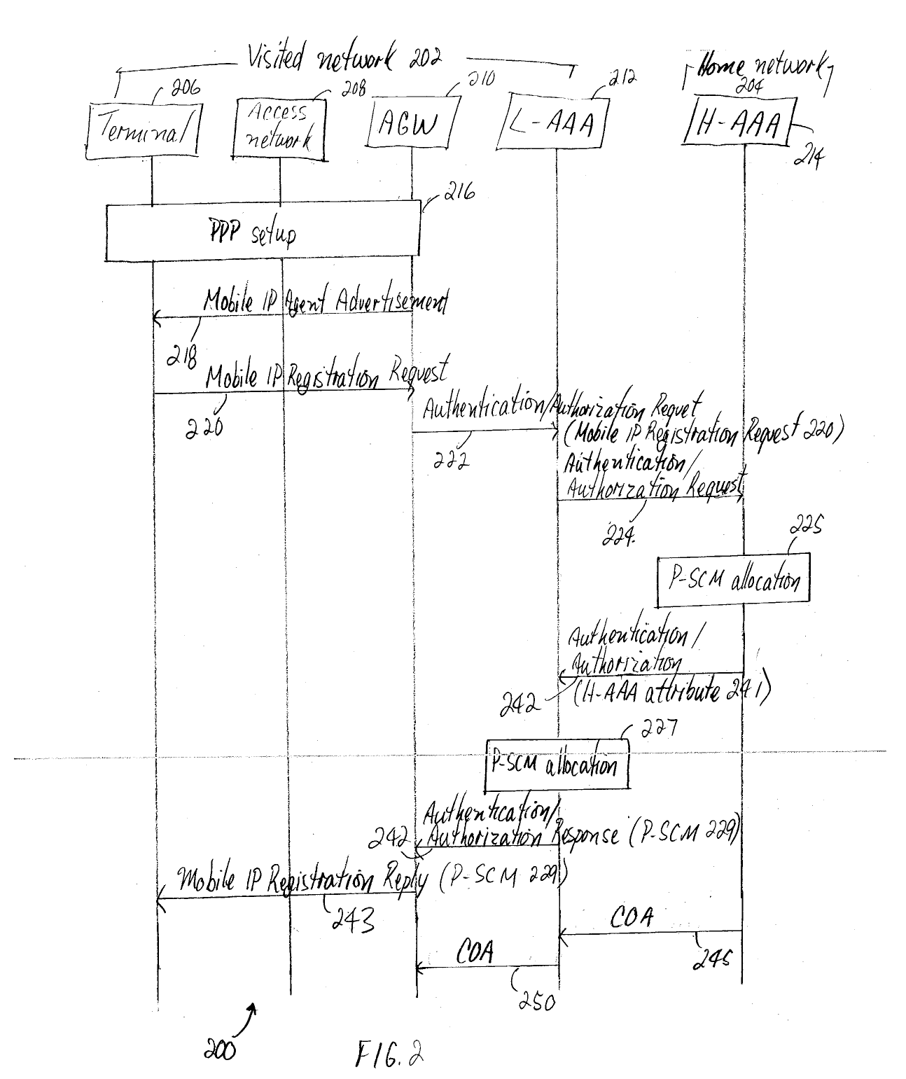

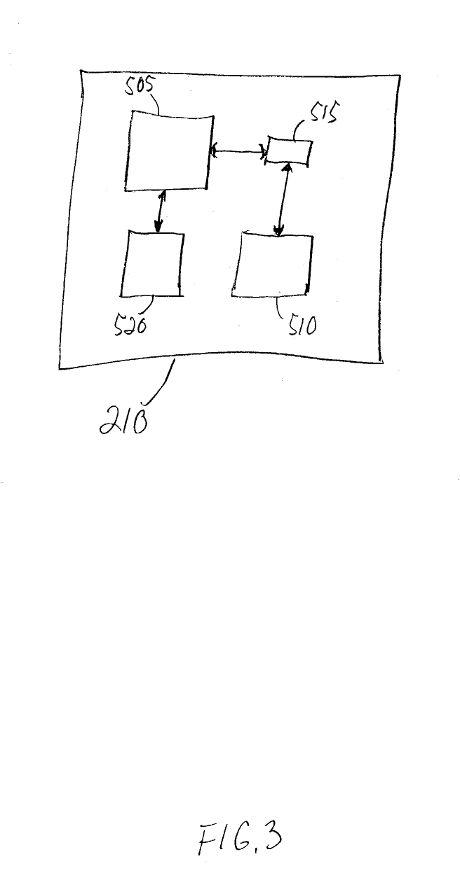

Reference is now made concurrently to FIG. 1, which illustrates a flow of messages for linking bearer and control in an ALL-IP network 200 and to FIG. 2, illustrating a flow of messages for linking bearer and control in the ALL-IP network 200. The ALL-IP network 200 comprises a Visited network 202 in which a terminal 206 may roam and a Home network 204 in which the terminal 206 is defined. The Visited network 202 comprises an Access Network 208 for accessing an Access Gateway (AGW) 210. The AGW 210 is responsible for controlling bearers for terminals that are located in the Visited network 202. A bearer is responsible for supporting traffic and transfer of packet data of multimedia services such as Internet multimedia conferences, Internet (or any IP Network) telephone calls and multimedia distribution that are provided to a terminal to a terminal (e.g. terminal 206). For instance, a bearer can be setup between the Access Network 208 and the AGW 210. Reference is now also made concurrently to FIG. 3, which illustrates a schematic diagram of the AGW 210. The AGW 210 comprises an input/output 505 for receiving, sending, and forwarding messages. The AGW 210 also comprises an internal memory 510 for storing an identity of P-SCM that controls a multimedia session signaling for a terminal (e.g. terminal 206), and a memory access 515 for accessing the memory 510. Furthermore, the AGW 210 comprises a bearer handler 520 for handling a bearer and for detecting any bearer loss.

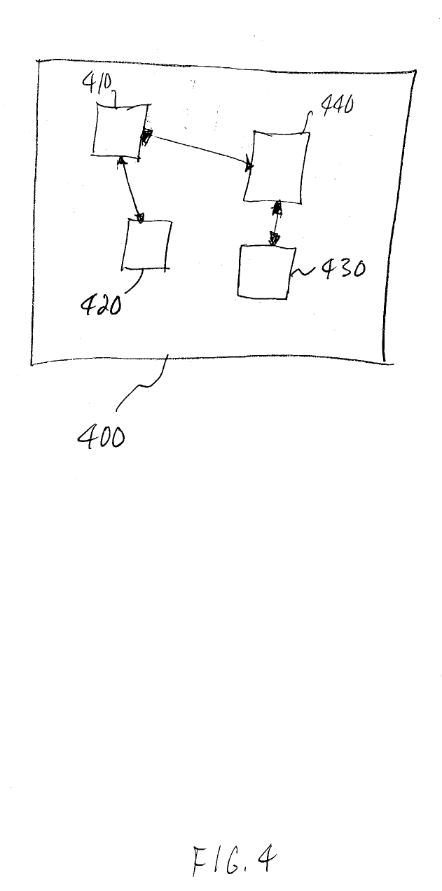

The Visited network 202 further comprises a Local-Authentication, Authorization, Accounting (L-AAA) server 212 for authorizing access to the ALL-IP network 200 and for communicating with a Home-AAA (H-AAA) 214 located in the Home network 204 of the terminal 206. Reference is now also concurrently made to FIG. 4, which illustrates an AAA server 400 such as the L-AAA 212 or the H-AAA 214. The AAA 400 comprises an input/output 410 for receiving, sending, and forwarding messages and an authentication functionality 430 for authenticating a terminal. The AAA 400 further comprises an internal database 430 for storing a list of P-SCMs' identity that can be later associated to a terminal located in the Visited network 202 and a processor 420 for allocating a P-SCM to a terminal based on P-SCM allocation criteria, which may be based for example on an IP address or Realm of the (NAI) or both. For instance, if a terminal makes a Simple IP access, the AAA 400 may assign a P-SCM for a multimedia session based on the terminal's IP address. However, if the terminal made a Mobile IP access, the AAA 400 may allocate a P-SCM based on a terminal Realm. The internal database 430 can also be used for storing an attribute of the AAA or an attribute received from another AAA.

As well known in the art, the Visited network 202 and the Home network 204 also comprise other packet data nodes such as databases, servers and gateways that have been omitted for clarity reasons. The Visited network 202 and the Home network 204 also comprise Proxy-Session Control Managers (P-SCMs), which have also been omitted for clarity purposes. However, it should be noted that the other packet data nodes and the P-SCMs are identified by IP addresses, and that such IP addresses are known by the AAA that serves the network, such as the H-AAA 214 in the Home network 204 or the L-AAA 212 of the Visited network 202. The P-SCM is responsible for controlling signaling for a particular multimedia session such as a Session Invitation Protocol (SIP) session in an ALL-IP network in which a terminal (e.g. terminal 206) is involved.

The method of the present invention can be applied to various IP networks such as a Universal Mobile Telecommunication System (UMTS) or Wireless Local Area Network (W-LAN). These networks are used in combination with an IP network such as the Internet for providing multimedia session to a terminal.

For exemplary purposes, the present invention could be applied to a CDMA2000 network. In such a network the AGW 210 is also called a Packet Data Serving Node (PDSN). The PDSN is the point of entry into the wireless packet data network. The PDSN performs two basic functions as follows: 1) Exchanging packets with a terminal over an Access network, also called the Radio Access Network (frequently referred as a Packet Control Function (PCF)); and 2) Exchanging packets with other IP networks so as to provide authentication and Mobile IP applications. The PDSN is used in connection with the L-AAA 212 server. More particularly, the L-AAA 212 is responsible for charging capabilities.

Furthermore, the terminal 206 can be a mobile station, a mobile telephone a personal data application, or any mobile equipment that can receive signal from a packet data network such as a Code Division Multiple Access (CDMA2000) network or any network that allows a subscriber of that equipment to communicate via a packet data network.

In a way to provide accurate charging correlation between a control signaling and an actual bearer usage for a particular multimedia session, the identity of the P-SCM has to be provided to the AGW 210 in order to allow the AGW 210 to communicate with the P-SCM. More particularly, the AGW 210 needs to know the identity of the P-SCM that currently serves the terminal 206. Therefore, charging information can be exchanged from the AGW 210 to the P-SCM. Also, it is needed for the P-SCM to be able to request tearing down of control resources upon loss of a bearer. For that reason, the AGW 210 must be able to inform the P-SCM of loss of that bearer.

When the terminal 206 accesses the ALL-IP network 200, it initiates an origination request (not shown) for requesting access to the Access Network 208. Upon reception of the origination request, the Access network 208 sets up a R-P connection (not shown) with the AGW 210. Following this, the AGW 210 initiates a PPP connection negotiation with the terminal 206 for establishing a PPP link protocol (PPP setup 216). During the PPP setup 216, the terminal 206 and the AGW 210 negotiate link and network layer parameters which may include Authenticated protocol.

If the terminal 206 is a Simple IP terminal, the PPP connection negotiation results in an IP address assignment to the terminal 206 following a Challenge Protocol (CHAP, EITF RFC 1994) authentication. However, if the terminal is a Mobile IP terminal, the AGW 210 sends a Mobile IP Agent Advertisement message 218 including a Mobile IP Agent Advertisement Challenge Extension to the terminal 206. Following this, the terminal 206 sends a Mobile IP Registration Request message 220 to the AGW 210, which includes authentication credentials such as a H-AAA Authentication Extension parameter. Next, the AGW 210 sends an Authentication/Authorization Request message 222 to the H-AAA 214 via the L-AAA 212 for validating the registration of the terminal 206. The Authentication/Authorization Request message 222 includes the Mobile IP Registration Request message 220 sent by the terminal 206.

Upon reception of the Authentication/Authorization Request message 222, the L-AAA 212 forwards it to the H-AAA 214. The H-AAA 214 processes the Authentication/Authorization Request message 222, authenticates the terminal 206, and forwards the Mobile IP Registration Request 220 to a serving Home Agent (HA) (not shown) located in the Home network 204 for validating the terminal 206. The HA validates the Mobile IP Registration Request message 220 and sends a reply to the H-AAA 214. At step 225, the H-AAA 214 determines that a P-SCM is needed for the terminal 206 and allocates a P-SCM for the terminal 206 (step 225). The P-SCM is allocated based on changeable policies managed by a network operator. The P-SCM can be allocated based on an algorithm that uses an attribute of the H-AAA 214 (H-AAA attribute), Service Level Agreement (SLA), and/or a profile of a subscriber of the terminal 206. If the allocation of the P-SCM is based on the profile of the subscriber of the terminal 206, a combination of the following parameters may be used: International Mobile Station Identity (IMSI), Network Access identifier (NAI), NAI realm, and P-SCM load status. It can be understood that the allocation criteria is not limited to these parameters. The allocated P-SCM may be located in the Visited network 202, the Home network 204 or any other network in the ALL-IP network 200.

When the P-SCM is allocated by the H-AAA 214, the identity of the P-SCM is encoded in an AAA attribute (P-SCM identity 240) for indicating that a P-SCM has been allocated for the terminal 206.

Next, the H-AAA 214 sends an Authentication/Authorization Response message 226 to the L-AAA 212. The message 226 includes the reply sent by the HA and the identity of the P-SCM allocated at step 225 (P-SCM identity 240). When the Authentication/Authorization Response message 226 is received at the L-AAA 212, the L-AAA 212 sends the Authentication/Authorization Response message 228 including the P-SCM identity 240 to the AGW 210. Next, upon reception of the message 228 the AGW 210 stores the P-SCM identity 240 and forwards it to the terminal 206 a Mobile IP Registration Reply 230. After the reception of the P-SCM identity 240, the terminal 206 may initiate communication for receiving multimedia service. In a particular case, the P-SCM may change over time during an active session based on a node or network failure. For that reason, a Change of Authorization (COA) message is sent from the H-AAA 212 (COA message 245) or from the L-AAA 212 (COA message 250) to the AGW 210. The COA includes a new P-SCM identity or necessary data such as a H-AAA attribute for allocating a new P-SCM. If the COA message 245 is sent from the H-AAA 214 to the LAAA 212, the L-AAA 212 forwards the COA 245 to the AGW 210 in the COA message 250. However, the COA message 250 can be sent without receiving COA message 245. Upon reception of the COA 250, the AGW 210 updates the stored P-SCM identity with a new P-SCM identity (not shown).

Reference is now made to FIG. 2, where alternatively, the H-AAA 214 requests the L-AAA 212 to allocate the P-SCM for the terminal 206. For doing so, an Authentication/Authorization Response message 242 is sent from the H-AAA 214. The Authentication/Authorization message 242 includes the attribute of the H-AAA 214 (H-AAA attribute 241) for indicating to the L-AAA 212 that the H-AAA 214 requests the L-AAA 212 to allocate the P-SCM to the terminal 206. When the Authentication/Authorization Response message 242 is received at the L-AAA, the L-AAA 212 determines at step 227 that it is needed to perform an algorithm such as the one described for the H-AAA 214 at step 225 and to allocate the P-SCM. Subsequently, the L-AAA 212 sends the Authentication/Authorization Response message 242 to the AGW 210 including the P-SCM identity 229. Next, upon reception of the message 242 the AGW 210 stores the P-SCM identity 229 and forwards it to the terminal 206 in a Mobile IP Registration Reply 243. After the reception of the P-SCM identity 229, the terminal 206 may initiate communication for receiving multimedia services.

Therefore receiving the identity of the allocated P-SCM form the L-AAA 212 or the H-AAA 214 can allow the correlation of charging by linking the control and bearer. More particularly, exchanges between the AGW 210 and the allocated P-SCM can be performed. For instance, at reception of the P-SCM identity 229, the AGW 210 may send an Authorization Request (not shown) to the allocated P-SCM including charging IDs generated by the AGW 210, a bearer ID, a Network Access identifier (NAI) and an identity of the terminal 206 such as its IP address. If the P-SCM does not have any pending multimedia session for the terminal 206, it replies with an indication that the terminal 206 is not registered to a multimedia session.

Furthermore, if the terminal 206 receives or initiates a multimedia session setup signaling that requires setup of a new bearer (R-P connection) with the AGW 210, the AGW 210 may send a new authorization request including an identity (e.g. IMSI or IP address) of the terminal 206 to the allocated P-SCM during the bearer setup. Since a multimedia session signaling is required to be processed by the allocated P-SCM, the P-SCM will recognize the identity of the subscriber of the terminal received from the AGW 210 and will reply with its own identification and charging identity to the AGW 210. The AGW 210 maps the charging identity received from the allocated P-SCM with the charging identities generated for the new bearer. Afterwards, the AGW 210 sends both identities to the L-AAA 212 and H-AAA 214.

It can be understood that some messages and therefore some parameters sent from the terminal 206 to the ALL-IP network 200 and vice versa are not mentioned nor described for clarity reasons. Also some messages and therefore some parameters sent between network elements in the ALL-IP network 200 are omitted for clarity reasons. Also, it should be clear for those skilled in the art of the invention that the invention is not limited to the examples described before, and that many other possibilities are also encompassed by the present invention. It should also be understood that FIG. 1 and FIG. 2 each depict a simplified network, and that many other nodes have been omitted for clarity reasons only.

Although several preferred embodiments of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for linking control and bearer for a multimedia session in an ALL-IP network, the method comprising steps of:
receiving at an Access Gateway (AGW) a Mobile IP Request message from a terminal;
requesting by the AGW authentication of the terminal at an Authentication, Authorization, and Accounting (AAA) server;
allocating at the AAA a Proxy Session Control Manager (P-SCM) for the terminal;
sending from the AAA an identity of the P-SCM to the AGW; and
storing at the AGW the identity of the allocated P-SCM for the terminal.

2. The method of claim 1, wherein the Mobile IP request message is sent in an Authentication/Authorization request message from the AGW to a Local-AAA.

3. The method of claim 1, wherein the step of allocating further comprises a step of:
using an algorithm and the Mobile IP request for determining the identity of the P-SCM.

4. The method of claim 1, wherein the identity of the P-SCM is sent from the AAA to the AGW in an Authentication/Authorization Response message.

5. The method of claim 1, further comprising a step of sending from the AGW to the terminal the identity of the P-SCM in a Mobile IP Registration Reply message.

6. An Access Gateway (AGW) for storing an identity of a Proxy-Session Control manager (P-SCM), the AGW being capable of:
receiving a Mobile IP request from a terminal;
forwarding the Mobile IP request to an AAA in an Authentication/Authorization Request message;
receiving an Authentication/Authorization Response message from the AAA, the message including an identity of a P-SCM allocated for the terminal; and
storing the identity of the P-SCM in an internal memory.

7. The AGW of claim 6, wherein the AGW is further capable of sending the identity of the allocated P-SCM to the terminal.

8. The AGW of claim 6, wherein the AGW is further capable of:
detecting a bearer loss for the terminal in an ALL-IP network;
informing the P-SCM allocated for the terminal using the stored identity of the P-SCM; and
correlating charging information for the terminal.

9. The AGW of claim 6, wherein the AGW is further capable of:
receiving a Change of Authorization (COA) message from the AAA;
updating an internal memory of the AGW.

10. An Authentication, Authorization, and Accounting (AAA) server for allocating a Proxy Session Control Manager (P-SCM) to a terminal, the AAA being capable of:
receiving an Authentication/Authorization Request message from an Access Gateway, the Authentication/Authorization Request message including a Mobile IP Request received from the terminal;
using the Mobile IP Request and an attribute of the AAA, allocating the P-SCM; and
informing the Access Gateway of the allocated P-SCM for the terminal.

11. The AAA of claim 10, wherein the AAA is further capable of:
forwarding the Authentication/Authorization Request message to a Home-AAA of the terminal; and
receiving an Authentication/Authorization Response message from the Home-AAA.
